(19) United States
(12) Patent Application Publication
(10) Pub. No.: US 2012/0170002 A1
(43) Pub. Date: Jul. 5, 2012

(54) LED PROJECTOR AND METHOD

(76) Inventors: Andrew J. Ouderkirk, Saint Paul, MN (US); Yifei Song, Singapore (SG); Amy S. Barnes, Saint Paul, MN (US); David S. Thompson, West Lakeland, MN (US); Sen Ching Ong, Singapore (SG); Andrew T. Tio, Singapore (SG); Robert S. Davidson, Bloomington, MN (US)

(21) Appl. No.: 13/395,525

(22) PCT Filed: Sep. 13, 2010
(86) PCT No.: PCT/US2010/048593

§ 371 Date: Mar. 12, 2012

Related U.S. Application Data
(60) Provisional application No. 61/242,527, filed on Sep. 15, 2009.

(51) Int. Cl. G03B 21/16; G02B 1/10

(52) U.S. Cl. 353/30; 353/52; 427/163.1

(57) ABSTRACT

A light emitting diode (LED) projector, an LED projector array, and a method of making the LED projector and LED projector array are provided. In general, an LED is disposed to inject light into an input aperture of a compound parabolic concentrator (CPC), disposed in a molded optical element. At least partially collimated light exits the output aperture of the CPC. The CPC has a portion of the surface free to expand and contract without degrading the performance of the LED projector.

### BACKGROUND

Illumination systems are used in many different applications, including projection display systems, backlights for liquid crystal displays and the like. Projection systems typically use one or more conventional white light sources, such as high pressure mercury lamps. The white light beam is usually split into three primary colors, red, green and blue, and is directed to respective image forming spatial light modulators to produce an image for each primary color. The resulting primary-color image beams are combined and projected onto a projection screen for viewing. Conventional white light sources are generally bulky, inefficient in emitting one or more primary colors, difficult to integrate, and tend to result in increased size and power consumption in optical systems that employ them.

More recently, light emitting diodes (LEDs) have been considered as an alternative to conventional white light sources. LEDs have the potential to provide the brightness and operational lifetime that would compete with conventional light sources. Current LEDs, however, especially green emitting LEDs, are relatively inefficient.

Microprojection is a display technology that encompasses light-emitting devices with a very small form factor. A representative example of microprojection technology is a recently announced microprojection engine from 3M Company based on a Liquid Crystal on Silicon (LCoS) spatial light modulator (SLM), a light emitting diode (LED) illuminator, and a compact polarizing beam splitter.

Smaller, brighter, more power efficient full-color microprojectors for portable and embedded applications such as a mobile phones and digital still cameras are desired. Such microprojectors preferably have the capability of projecting a still or moving image. The trend in projector development tends towards engines having a higher pixel count, higher brightness, smaller volume, and lower power consumption.

### SUMMARY

In one aspect, the present disclosure provides a light emitting diode (LED) projector that includes a heat extraction substrate, a molded optical element, and an LED. The molded optical element includes an input aperture, an output aperture, and an inner surface defining a cavity. The molded optical element further includes an outer surface at least partially surrounding the inner surface, and a portion of the outer surface in thermal contact with the heat extraction substrate. The molded optical element further includes a mold material filling a space between the inner surface and the outer surface. The LED is disposed to inject a light beam into the input aperture of the molded optical element, wherein the injected light beam travels through the cavity and exits the output aperture as a partially collimated light beam.

In another aspect, the present disclosure provides an LED projection array that includes a heat extraction substrate, a first molded optical element, a second molded optical element, and a third molded optical element. Each of the first molded optical element, second molded optical element, and third molded optical element includes an input aperture, an output aperture, and an inner surface defining a cavity. Each of the first molded optical element, second molded optical element, and third molded optical element further includes an outer surface at least partially surrounding the inner surface, a first portion of the outer surface in therma contact with the heat extraction substrate, and a mold material filling a space between the inner surface and the outer surface. The LED projection array further includes a first LED disposed to inject a first light beam into the input aperture of the first molded optical element, a second LED disposed to inject a second light beam into the input aperture of the second molded optical element, and a third LED disposed to inject a third light beam into the input aperture of the third molded optical element. Each of the first, second, and third injected light beam exits the respective output aperture as a first, a second, and a third partially collimated light beam, respectively, and at least a second portion of the mold material is continuous across at least two of the first molded optical element, the second molded optical element and the third molded optical element.

In yet another aspect, the present disclosure provides an LED projection array that includes a heat extraction substrate, a first molded optical element and a second molded optical element. Each of the first molded optical element and the second molded optical element includes an input aperture, an output aperture, and an inner surface defining a cavity. Each of the first molded optical element and the second molded optical element further includes an outer surface at least partially surrounding the inner surface, a first portion of the outer surface in thermal contact with the heat extraction substrate, and a mold material filling a space between the inner surface and the outer surface. The LED projection array further includes a first LED disposed to inject a first light beam into the input aperture of the first molded optical element and a second LED disposed to inject a second light beam into the input aperture of the second molded optical element. Each of the first and second injected light beam exits the respective output aperture as a first and a second partially collimated light beam, respectively, and wherein at least a second portion of the mold material is continuous across the first molded optical element and the second molded optical element.

In yet another aspect, the present disclosure provides a method for producing an LED projector that includes coating an inner surface of a mold with a reflective material, the mold including an outer surface surrounding the inner surface, a cavity defined by the inner surface, an input aperture, and an output aperture; and a mold material filling a space between the inner surface and the outer surface. The method for producing an LED projector further includes disposing a portion of the outer surface of the mold in thermal contact with a heat extraction substrate, and positioning an LED to inject a light beam into the input aperture, wherein the injected light beam travels through the cavity and exits the output aperture as a partially collimated light beam.

In yet another aspect, the present disclosure provides a method for producing an LED projector that includes coating an inner surface of a mold with a reflective material; the mold including an outer surface surrounding the inner surface, a cavity defined by the inner surface, an input aperture, and an output aperture; and a mold material filling a space between the inner surface and the outer surface. The method for producing an LED projection further includes disposing a first portion of the outer surface in thermal contact with a heat extraction substrate, and positioning an LED to inject a light beam into the input aperture, wherein the injected light beam travels through the cavity and exits the output aperture as a partially collimated light beam. The method for producing an LED still further includes filling the cavity with a curable resin, curing the curable resin, and removing a second portion of the mold from the cured resin.

In yet another aspect, the present disclosure provides a method for producing an LED projector that includes coating an inner surface of a mold with a reflective material; the mold including an outer surface surrounding the inner surface, a cavity defined by the inner surface, an input aperture, and an output aperture; and a mold material filling a space between the inner surface and the outer surface, wherein a portion of the mold material comprises an elastic material. The method for producing an LED projector further includes disposing a first portion of the outer surface in thermal contact with a heat extraction substrate, and positioning an LED to inject a light beam into the input aperture, wherein the injected light beam travels through the cavity and exits the output aperture as a partially collimated light beam. The method for producing an LED projector still further includes filling the cavity with a curable resin and curing the curable resin.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings, where like reference numerals designate like elements, and wherein:

FIG. 1 is a schematic cross-sectional view of an LED projector;

FIG. 2 is a schematic cross-sectional view of an LED projector;

FIG. 3 is a schematic cross-sectional view of an LED projector;

FIG. 4 is a schematic top view of an LED projector array;

FIG. 5 is a schematic top view of an LED projector array; and

FIGS. 6A-6C are perspective views of a process for an LED projector array.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

This application describes an illumination device, such as an LED projector, where a molded optical element at least partially collimates light emitted from an LED die. The LED projector can also generally be described as a projection illuminator, that is, the “light engine” of a projection device. The molded optical element includes a cavity defined by an inside surface, where a portion of the inside surface is mechanically constrained by a mold material that has a lower coefficient of thermal expansion (CTE) than a material filling the cavity. The molded optical element is allowed to expand or contract on a portion of the inside surface that is not constrained by the mold material.

In one aspect, the molded optical element includes a Compound Parabolic Concentrator (CPC) shaped cavity to collimate the light. CPCs are extremely efficient devices for collimating light emitted from an emitting device, such as an LED, with little increase in etendue. There are two general categories of CPCs, the first is a hollow CPC, formed from a cavity with a reflective coating such as a metal or a dielectric coating the interior of the cavity. The second category is a solid CPC, where light is reflected from the surfaces of the CPC by Total Internal Reflection (TIR).

Solid CPCs have a number of advantages over hollow CPCs, particularly where the light source is encapsulated with a transparent resin in order to increase the light extraction efficiency. In one particular embodiment, the solid CPC material can be optically and thermally stable. Optical and thermal stability can be desirable, particularly when the solid CPC is used in compact systems where the light source can generate high temperatures and large thermal gradients.

Glass and cast polymers have been used as the material for solid CPCs. However, glass CPCs can be expensive to fabricate, and typical engineering polymers used for casting CPCs often do not have adequate thermal and photo stability. In contrast to glass and cast polymers, silicones have a very good combination of thermal and photo stability, and are often used as an encapsulant for LEDs. Unfortunately, silicones and many other polymers with properties suitable for making CPCs have very high Coefficients of Thermal Expansion (CTE) and have a relatively low tensile strength. Techniques of reducing silicone's CTE such as adding inorganic fillers have not been very effective with application in CPCs, since these fillers increase optical scattering in the silicone, and also increase the etendue of light emitted from the CPC. The high CTE limits the application of silicones for making CPCs.

Compact LED projectors can require inexpensive and efficient primary optics between the LED die and the spatial light modulator. These primary optics should also be mechanically, photolytically, and thermally, robust. A CPC having at least a portion of the side of the CPC mechanically unconstrained, and at least another portion of the CPC that is mechanically constrained, can allow materials with higher CTEs to be used to form CPCs.

The molded CPCs can be used for projection illuminators, where one or more LEDs emitting the same or different colors may be positioned at the input aperture of an individual molded CPC. The molded CPCs may be in an array of two or more CPCs, with each CPC being illuminated by one or more LEDs. Some of the CPCs may be hollow, and others in the same array may be solid. The hollow and filled CPCs may have different dimensions in order, for example, to emit light with a similar etendue. The molded CPCs may also be coupled to photovoltaic devices, where light is directed into the large entrance of the CPC, and the light is efficiently coupled to the photovoltaic device.

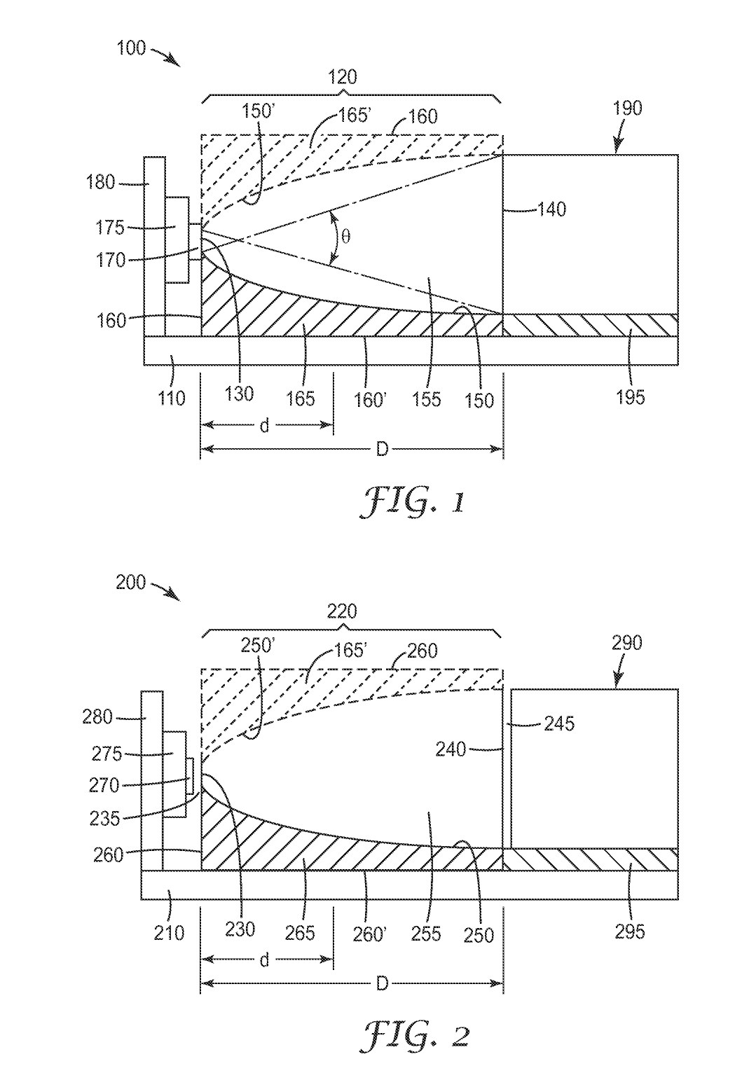

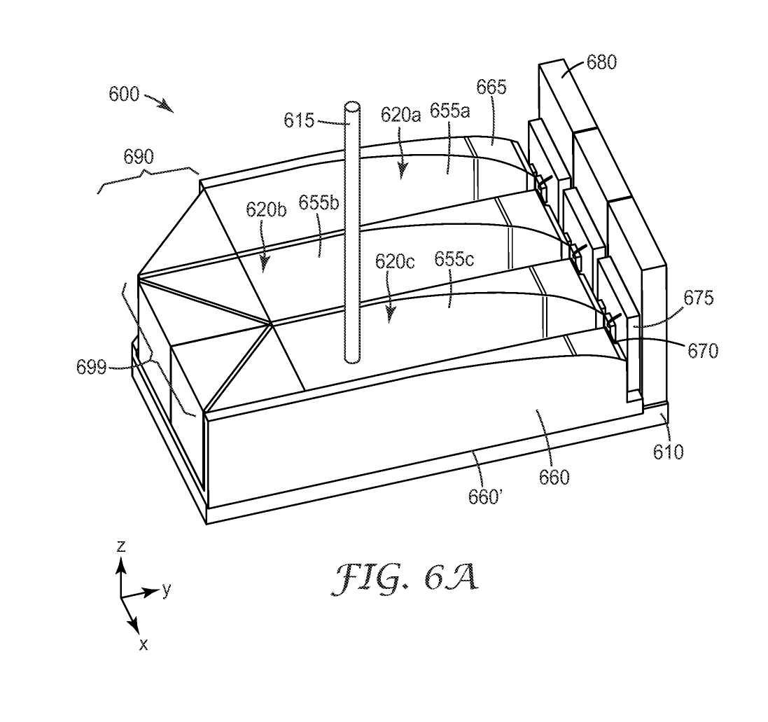

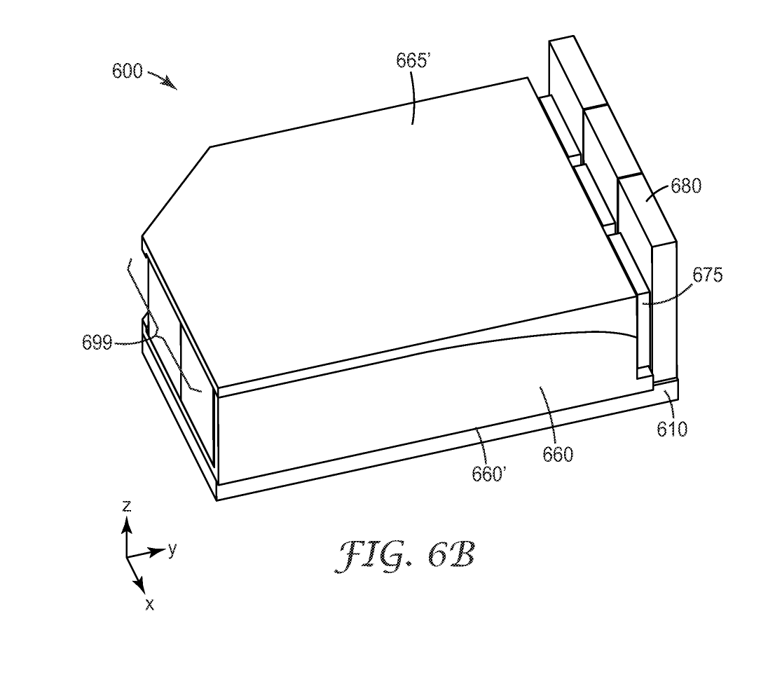

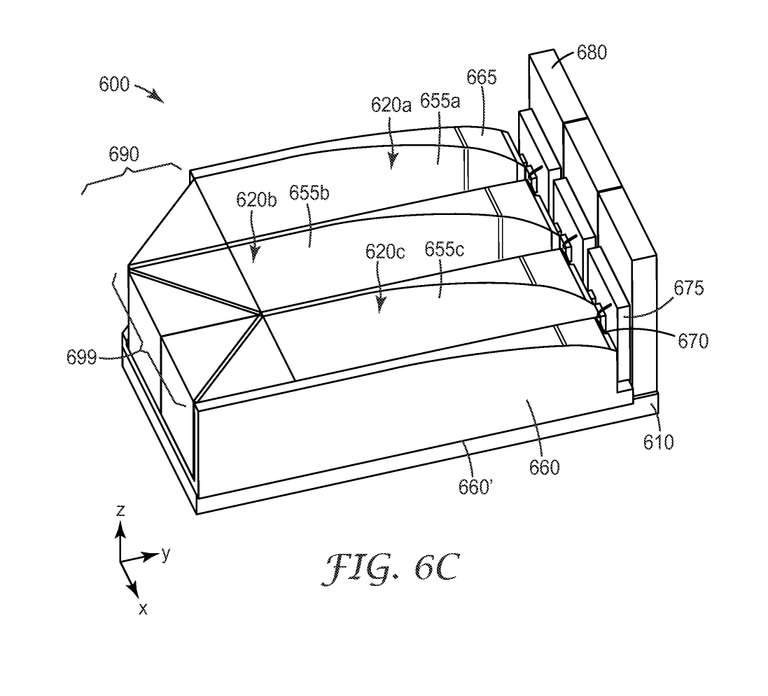

FIG. 1 is a schematic cross-sectional view of an LED projector 100 according to one particular aspect of the disclosure. The schematic cross-sectional view shown in FIG. 1 can be related to a slice in the “y-z” plane of FIG. 6B. LED projector 100 includes a molded optical element 120 disposed on a heat extraction substrate 110. The molded optical element 120 includes a first mold material 165 and a second mold material 165′ that at least partially surrounds a cavity 155. The cavity 155 is defined by an inner surface 150, 150′, an input aperture 130, and an output aperture 140. The molded optical element further includes an outer surface 160, and at least a portion 160′ of the outer surface 160 is in thermal contact with the heat extraction substrate 110.

The heat extraction substrate 110 can be any known material, for example, aluminum or other metals, having a suitably high thermal conductivity, to provide sufficient heat extraction and heat dissipation from the LED projector 100. The first mold material 165 can be made from a material having a CTE ranging from about 5 to about 100 ppm/K (parts per million/degree Kelvin), and include, for example, metals; polymers such as polyphenylene sulfide (PPS), polyetheretherketone (PEEK), or a liquid crystal polymer (LCP); or ceramics. In some cases, the first mold material 165 can be made from a material having a higher CTE than 100 ppm/K, for example, a silicone material having a CTE in the range of about 300 ppm/K. The higher CTE material can be used when the primary function of the first mold material 165 is to prevent stress concentration at an LED die, as described elsewhere. The second mold material 165′ can be the same or different from the first mold material 165, as described elsewhere.

The cavity 155 can have any shape suitable for partially collimating a light beam passing from the input aperture 130 through the output aperture 140. In one particular embodiment shown in FIG. 1, the cavity has a compound parabolic concentrator (CPC) shaped cross section. The CPC shaped cross section can be, for example, a circular CPC, a rectangular CPC, or a square CPC. In some cases, a rectangular CPC or a square CPC can be preferred. In the description that follows, a square CPC can be especially preferred. CPC designs are well known, and descriptions can be found, for example, in LED-Based Projections Systems, Yu et al., J. Display. Technol., Vol. 3, No. 3, 295-303, (2007); and also in LED-based mini-projectors, Krijn et al., Proc. of SPIE Vol. 6196 619602, 1-12, (2006). The CPC shape can be characterized in part by defining an included angle θ that is related to the relative areas of the input surface 130 and the output surface 140. The included angle θ can be related to the ratio (or concentration) “C” of the area of the output surface 140 to the area of the input surface 130 by the relationship C=(1/sin(θ/2)). Generally, for a CPC cavity design, all of the light entering the input aperture 130 exits the output aperture 140 within the included angle θ. In this manner, for example, Lambertian emission from the LED 170 injected into the input aperture 130, results in partially collimated light (that is, light beams within the included angle θ) exiting the output aperture 140. In one particular embodiment, the included angle θ can range from about 5 to about 50 degrees, from about 10 to about 30 degrees, or from about 10 to about 20 degrees.

In one particular embodiment, the cavity 155 can be a hollow CPC, and the first mold material 165 and the second mold material 165′ can remain in place to define the molded optical element 120. In one particular embodiment, the inner surface 150, 150′ of cavity 155 can be made to reflect light, by techniques known to those of skill in the art. In some cases, a reflective metal such as silver or a silver alloy, a dielectric such as magnesium fluoride, or a combination, can be disposed on the inner surface 150. In some cases, a multilayer dielectric interference reflector, such as alternating layers of inorganic oxides or a polymeric multilayer interference reflector can be disposed on the inner surface 150, 150′.

In another particular embodiment, the cavity 155 can include a solid CPC, and the second mold material 165′ may be removed from the molded optical element 120. The solid CPC can be made from any optically transparent polymer, including, for example, silicones such as polymethylsilicone and polyphenylsilicone, epoxies, acrylates, cyclo-olefin copolymers, and other transparent polymers. The inner surface 150′ of the solid CPC may be uncoated, or it can be coated by a flexible reflective coating, such as a polymeric interference mirror, protective coatings, dielectric mirrors, dielectric coatings on metal, and the like.

Various light sources can be used in a projection device, such as lasers, laser diodes, LEDs, UV-LEDs, organic LED's (OLED's), and non solid-state light sources such as ultra high pressure (UHP), halogen or xenon lamps with appropriate collectors or reflectors. An LED light source can have advantages over other light sources, including economy of operation, long lifetime, robustness, efficient light generation and improved spectral output. The LED can be a visible light emitting LED such as a blue, red, or green LED. The LED can instead be a blue- or UV-LED capable of emitting light to a downconverter element to generate different of colors of light, as described, for example, in Published PCT Patent Application No. WO2008/109296 entitled ARRAY OF LUMINESCENT ELEMENTS.

In one particular embodiment, the LED projector 100 further includes an LED 170 disposed to inject a light beam into the input aperture 130. In one particular embodiment, the LED 170 can have an output surface in contact with the input aperture 130, as shown in FIG. 1, to provide coupling of the light emitted from the LED into the input aperture 130. The LED 170 can be mounted on a circuitized substrate 175 that can provide electrical contacts to energize the LED 170. The circuitized substrate 175 can be mounted to a second heat extraction substrate 180 that is in thermal contact with the heat extraction substrate 110.

Generally, the LED 170 includes a light emitting surface that is optically coupled to the input aperture 130 of the cavity 155. The expansion and contraction of the molded optical element 120 that can occur with temperature changes could potentially degrade the optical coupling, and could also potentially change the optics of the cavity 155, as mentioned elsewhere. At least a portion of the cavity 155, indicated in FIG. 1 by the distance “d” is held in registration with the LED 170.

In one particular embodiment, when the cavity 155 is a hollow CPC, registration is maintained by the attachment of the first mold material 165 along the portion 160′ of the outer surface that is in thermal contact with the heat extraction substrate 110.

In another particular embodiment, when the cavity 155 is a solid CPC, registration is maintained by constraining solid CPC cavity 155 along at least a portion of the inner surface 150 (along the distance “d”) of the first mold material 165. The second mold material 165′ is removed from the molded optical element 120, and the portion 150′ of the inner surface is a free-surface which can expand or contract without degrading the optical coupling of the solid CPC to the LED. The constrained distance “d” can vary from about 5% up to about 100% of the total depth “D” of the cavity 155. At least a second portion of the inner surface 150 is a “free” surface, and is not constrained from moving due to expansion or contraction due to temperature changes. The constrained solid CPC can be bonded to the mold by techniques known to those of skill in the art, and can also be allowed to partially de-bond from the mold in some part of the manufacturing or used of the device.

The molded optical element 120 with a removed second mold material 165′ allows the material in cavity 155, for example, silicone (having a CTE of approximately 300 ppm/K), to expand and contract without substantially affecting the light that is collimated by the solid CPC. Similar effects may be achieved by having free surfaces on more than one portion of the CPC. In one particular embodiment, the first mold material 165 may be a relatively narrow strip that supports about 5% of the total surface area of the CPC. In general, support is more important near the LED, to maintain optical coupling and the optics of collimation. As such, the support may be over about 5% to about 80% of the outer surface area of the CPC.

In one particular embodiment, the LED projector 100 further includes an optional color combiner element 190 disposed to receive light from the output aperture 140. The optional color combiner element 190 can include, for example, glass prisms that can have an optional support 195 in thermal contact with heat extraction substrate 110, as described elsewhere. Optional support 195 can be fabricated from first mold material 165, and can be fabricated integral with the optical element 120. Optional support 195 can provide an alignment structure to assist positioning optional color combiner element 190 relative to the output aperture 140.

FIG. 2 is a schematic cross-sectional view of an LED projector 200, according to one particular aspect of the disclosure. The schematic cross-sectional view shown in FIG. 2 can be related to a slice in the “y-z” plane of FIG. 6B. LED projector 200 includes a molded optical element 220 disposed on a heat extraction substrate 210. Each of the elements 210-295 shown in FIG. 2 correspond to like-numbered elements 110-195 shown in FIG. 1, which have been described previously. For example, the description of heat extraction substrate 110 in FIG. 1 corresponds to the description of heat extraction substrate 210 in FIG. 2, and so on.

In FIG. 2, the input aperture 230 of the cavity 255 is separated from the LED 270 by a first gap 235, and the output aperture 240 is separated from the optional color combiner 290 by a second gap 245. In one particular embodiment, first gap 235 can result from a thin film (not shown) being placed between the molded optical element 220 and the LED 270 prior to fabricating a solid CPC cavity 255, as described elsewhere. Second gap 245 can also result from a thin film (not shown) being placed between the molded optical element 220 and the optional color combiner 290 prior to fabricating a solid CPC cavity 255, as described elsewhere. The thin film(s) can then be removed, thereby providing a smooth surface on input aperture 230 and output aperture 240, respectively.

In one particular embodiment, at least one of the first gap 235 and the second gap 245 can be filled with air. In one particular embodiment, at least one of the first gap 235 and the second gap 245 can be filled with a material having an index of refraction lower than the index of refraction of the material in cavity 155. In some cases, the material can have an index of refraction from about 1.0 (for example, air) to about 1.6 or less (for example, silicone). In one particular embodiment, the second gap 245 can be filled with a material having an index of refraction lower than the index of refraction of the material of the optional color combiner 290.

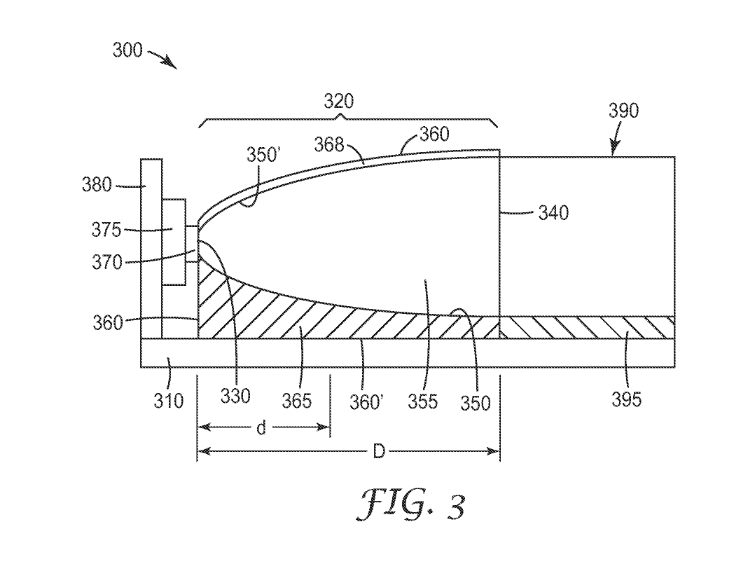

FIG. 3 is a schematic cross-sectional view of an LED projector 300, according to one particular aspect of the disclosure. The schematic cross-sectional view shown in FIG. 3 can be related to a slice in the “y-z” plane of FIG. 6B. LED projector 300 includes a molded optical element 320 disposed on a heat extraction substrate 310. Each of the elements 310-395 shown in FIG. 3 correspond to like-numbered elements 110-195 shown in FIG. 1, which have been described previously. For example, the description of heat extraction substrate 110 in FIG. 1 corresponds to the description of heat extraction substrate 310 in FIG. 3, and so on.

In FIG. 3, the second mold material 365′ has been removed from molded optical element 320. A membrane 368 having outer surface 360 can instead be positioned along inner surface 350′. The reflective membrane 368 can be a reflective membrane, or can be made reflective by any of the techniques described elsewhere. Preferably, the reflective membrane can have a modulus that allows the expansion and contraction of solid CPC cavity 355 due to temperature changes.

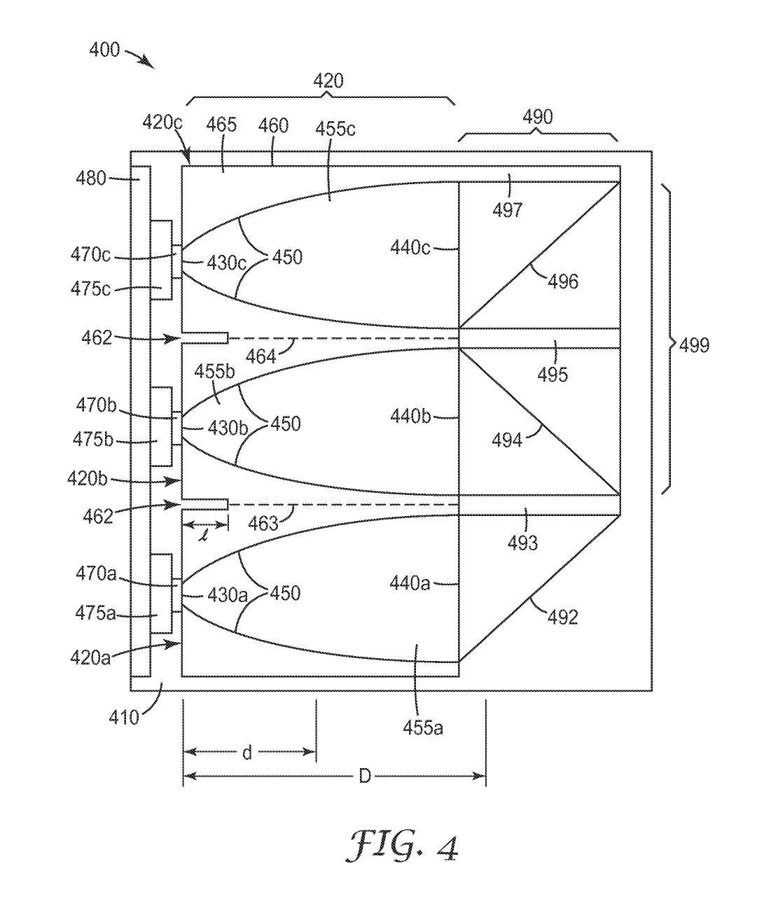

FIG. 4 is a schematic top view of an LED projector array 400, according to one aspect of the disclosure. The schematic top view shown in FIG. 4 can be related to a slice in the “x-y” plane of FIG. 6B. LED projector array 400 includes a first, a second, and a third molded optical element, 420a, 420b, and 420c. Each of the first, second, and third molded optical elements 420a, 420b, and 420c can be integrated into a single molded optical element 420, and are in thermal contact with a heat exchange surface 410. The single molded optical element 420 can include an expansion slit 462 having a length “l” disposed on a first line 463 between the first and second molded optical elements 420a and 420b. The single molded optical element 420 can further include an expansion slit 462 having a length “l” disposed on a second line 464 between the second and third molded optical elements 420b and 420c.

In FIG. 4, each of the elements 410-495 shown in FIG. 4 correspond to like-numbered elements 110-195 shown in FIG. 1, which have been described previously. For example, the description of heat extraction substrate 110 in FIG. 1 corresponds to the description of heat extraction substrate 410 in FIG. 4, and so on. For simplicity, the following description of the elements shown in FIG. 4 assumes that a first, a second, and a third cavities (455a, 455b, 455c) are solid CPCs; however, one or more of the first, second, and third cavities (455a, 455b, 455c) could instead be hollow cavities, as described elsewhere.

In FIG. 4, a first, a second, and a third LED (470a, 470b, 470c) are disposed to inject light into a first, a second, and a third input aperture (430a, 430b, 430c) of the first, second, and third molded optical element (420a, 420b, 420c), respectively. In one particular embodiment, each of the first, second, and third LEDs (470a, 470b, 470c) are capable of injecting a different wavelength of light, for example, red, green, and blue colored light. In another embodiment, at least two of the first, second, and third LEDs (470a, 470b, 470c) are capable of injecting the same wavelength of light.

Each of the first, second, and third LEDs (470a, 470b, 470c) can be mounted on a first, a second, and a third circuitized substrate (475a, 475b, 475c), respectively, that can provide electrical contacts to energize the respective LED. The respective circuitized substrates (475a, 475b, 475c) can be mounted to a second heat extraction substrate 480 that is in thermal contact with the heat extraction substrate 410. In one particular embodiment shown in FIG. 4, each of the first, second, and third LEDs (470a, 470b, 470c) can be positioned in contact with the first, second, and third input aperture (430a, 430b, 430c). In another embodiment, a gap (not shown) similar to that shown in FIG. 2, can be disposed between at least one of the first, second, and third LEDs (470a, 470b, 470c) and the respective input aperture (430a, 430b, 430c).

Registration between each of the first, second and third LEDs (470a, 470b, 470c) and the respective input aperture (430a, 430b, 430c) is maintained by constraining each respective solid CPC cavity (455a, 455b, 455c) along at least a portion of the inner surface 450 (for example, along the distance “d”) of the first mold material 465, as described elsewhere. At least a second portion of the inner surface 450 is a “free” surface, and is not constrained from moving due to expansion or contraction due to temperature changes.

In FIG. 4, an optional color combiner element 490 is disposed to accept light from a first, a second, and a third output aperture (440a, 440b, 440c), and output a combined light from a projector aperture 499. Projector aperture 499 can have a cross-sectional area that is less than the sum of the first, second, and third output apertures (440a, 440b, 440c) as shown in FIG. 4. The optional color combiner element 490 can include several prisms as shown in FIG. 4, the prisms having a first, a second, and a third diagonal element 492, 494, 496, that can be, for example: dichroic filters adapted to reflect one or more wavelength of light and transmit other wavelengths of light, polarizers such as reflective polarizers, retardation plates such as quarter-wave plates, and the like.

Other optical films can be disposed between the prisms as shown in FIG. 4, such as first, second, and third optical films 493, 495, 497 that can also be, for example, dichroic filters, polarizers such as reflective polarizers, retardation plates such as quarter-wave plates, and the like. Arrangement of various optical elements and films in color combiners can be found, for example, in PCT Patent Publication Nos. WO2008/144207 (Magarill et al.), WO2009/085856 (English, et al.), and WO2009/086310 (Magarill et al.); PCT Patent Application Nos. US2008/087369 (Bruzzone et al.), and US2008/088020 (Magarill et al.); and U.S. Patent Application Nos. 61/116072 (Ouderkirk et al.) and 61/116061 (Ouderkirk et al.).

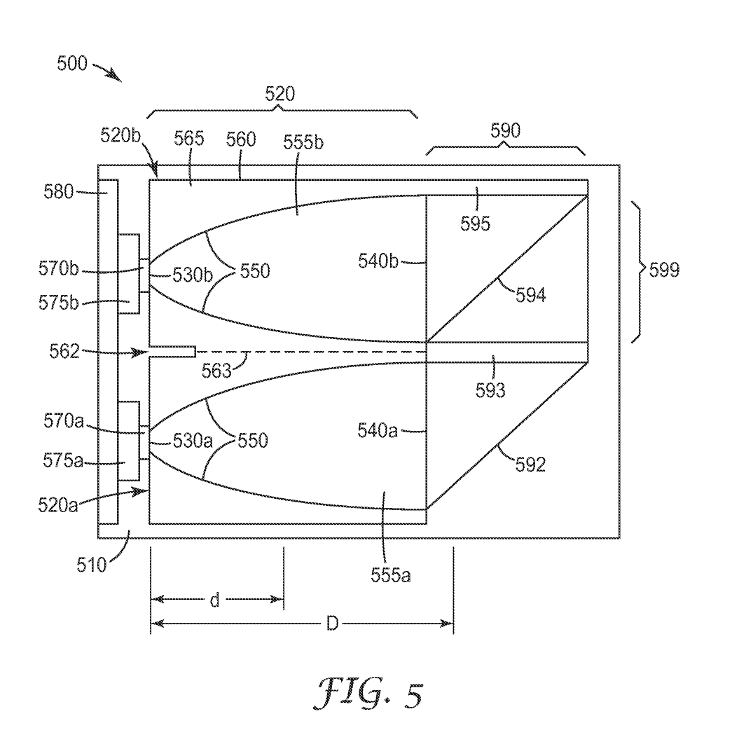

FIG. 5 is a schematic top view of an LED projector array 500, according to one aspect of the disclosure. The schematic top view shown in FIG. 5 can be related to a slice in the “x-y” plane of FIG. 6B. LED projector array 500 includes a first and a second molded optical element, 520a, 520b. Each of the first and second molded optical elements 520a, 520b can be integrated into a single molded optical element 520, and are in thermal contact with a heat exchange surface 510. The single molded optical element 520 can include an expansion slit 562 having a length “l” disposed on a line 563 between the first and second molded optical elements 520a and 520b.

In FIG. 5, each of the elements 510-595 shown in FIG. 5 correspond to like-numbered elements 110-195 shown in FIG. 1, which have been described previously. For example, the description of heat extraction substrate 110 in FIG. 1 corresponds to the description of heat extraction substrate 510 in FIG. 5, and so on. For simplicity, the following description of the elements shown in FIG. 5 assumes that a first and a second cavity (555a, 555b) are solid CPCs; however, one or more of the first and second cavities (555a, 555b) could instead be hollow cavities, as described elsewhere.

In one particular embodiment shown in FIG. 5, a first LED 570a, is disposed to inject light into a first input aperture 530a of the first molded optical element 520a. A second and a third LED (570b, 570c) are disposed to inject light into a second input aperture 530b of the second molded optical element 520b. In one particular embodiment, each of the first, second, and third LEDs (570a, 570b, 570c) are capable of injecting a different wavelength of light, for example, red, green, and blue colored light. In another embodiment, at least two of the first, second, and third LEDs (570a, 570b, 570c) are capable of injecting the same wavelength of light.

Each of the first, second, and third LEDs (570a, 570b, 570c) can be mounted on a first and a second circuitized substrate (575a, 575b), respectively, that can provide electrical contacts to energize the respective LED. The respective circuitized substrates (575a, 575b) can be mounted to a second heat extraction substrate 580 that is in thermal contact with the heat extraction substrate 510. In one particular embodiment shown in FIG. 5, each of the first, second, and third LEDs (570a, 570b, 570c) can be positioned in contact with the first and second input aperture (530a, 530b). In another embodiment, a gap (not shown) similar to that shown in FIG. 2, can be disposed between at least one of the first, second, and third LEDs (570a, 570b, 570c) and the respective input aperture (530a, 530b).

Registration between each of the first, second and third LEDs (570a, 570b, 570c) and the respective input aperture (530a, 530b) is maintained by constraining each respective solid CPC cavity (555a, 555b) along at least a portion of the inner surface 550 (for example, along the distance “d”) of the first mold material 565, as described elsewhere. At least a second portion of the inner surface 550 is a “free” surface, and is not constrained from moving due to expansion or contraction due to temperature changes.

In FIG. 5, an optional color combiner element 590 is disposed to accept light from a first and a second output aperture (540a, 540b), and output a combined light from a projector aperture 599. Projector aperture 599 can have a cross-sectional area that is less than the sum of the first and second output apertures (540a, 540b), as shown in FIG. 5. The optional color combiner element 590 can include several prisms as shown in FIG. 5, the prisms having a first and a second diagonal element 592, 594, that can be, for example: dichroic filters adapted to reflect one or more wavelength of light and transmit other wavelengths of light, polarizers such as reflective polarizers, retardation plates such as quarter-wave plates, and the like.

Other optical films can be disposed between the prisms as shown in FIG. 5, such as first and second optical films 593, 595 that can also be, for example, dichroic filters, polarizers such as reflective polarizers, retardation plates such as quarter-wave plates, and the like. Arrangement of various optical elements and films in color combiners can be found, for example, in PCT Patent Publication Nos. WO2008/144207 (Magarill et al.), WO2009/085856 (English, et al.), and WO2009/086310 (Magarill et al.); PCT Patent Application Nos. US2008/087369 (Bruzzone et al.), and US2008/088020 (Magarill et al.); and U.S. Patent Application Nos. 61/116072 (Ouderkirk et al.) and 61/116061 (Ouderkirk et al.).

FIGS. 6A-6C are perspective views of a process for producing an LED projector array 600, according to one aspect of the disclosure. The perspective view in FIGS. 6A-6C can also aid in visualizing the cross-sectional and top views shown previously in FIGS. 1-5. For example, FIGS. 1-3 show cross-sectional views in the “y-z” plane, and FIGS. 4-5 show top views in the “x-y” plane. In FIGS. 6A-6C, each of the elements 610-699 shown in FIG. 6 correspond to like-numbered elements 410-499 shown in FIG. 4, which have been described previously. For example, the description of heat extraction substrate 410 in FIG. 4 corresponds to the description of heat extraction substrate 610 in FIG. 6, and so on.

LED projector array 600 includes a first, a second, and a third molded optical element, 620a, 620b, and 620c. Each of the first, second, and third molded optical elements 620a, 620b, and 620c can be integrated into a single molded optical element as shown in FIG. 6A-6C, and are in thermal contact with a heat exchange surface 610. The single molded optical element can include at least one expansion slit (not shown), as described elsewhere. The molded optical elements (620a, 620b, 620c) can include a mold material 665 that can be formed by one of several conventional approaches, including injection molding a polymer, cast and curing a polymer in a mold, metal injection molding, direct machining, and stamping.

In FIG. 6A, a reflective material has been coated on the inner surfaces of a mold material 665, that form the boundaries of a first, a second, and a third cavity (655a, 655b, 655c) of the first, second and third molded optical elements (620a, 620b, 620c), respectively. Suitable coatings include physical vapor coatings such as magnesium fluoride, fluorocarbons, metals such as aluminum or silver, polymeric multilayer optical films, dielectric coatings such as those based on one of more layers of silicon oxides and titanium dioxide, and combinations thereof. After preparation of the reflective surfaces, LED 670, circuitized substrate 675, second heat extraction substrate 680, and optional color converter element 690 are positioned as shown in FIG. 6A.

At least one of a first, a second, and a third cavity (655a, 655b, 655c) is then filled with a suitable curable resin, such as, for example, an epoxy, an acrylate, a thermally cured silicone, or a photocurable silicone. In one particular embodiment shown in FIG. 6A, a needle 615 can be used to fill the third cavity 655c. The remaining first and second cavities (655a, 655b) can also be filled with the curable resin, or they can be left hollow, as shown in FIGS. 6A-6C.

In FIG. 6B, a second mold material 665′ can then be place over the first mold material 660, and the curable resin can be cured. The second mold surface may be flat, or shaped to produce the desired surface shape for the cavity. If the curable resin is photocured, one or more of the first mold material 665, the second mold material 665′, or one of the ends of the cavity (for example, a projection aperture 699) must be transparent to the curing radiation. If the curable resin is thermally cured, the mold materials should be stable at the curing temperatures. The resin may be cured at the intended operating temperature of the device, so that the free surface of the cavity will have the desired optical figure. It may be preferable to initiate curing at the narrow end of the CPC to ensure integrity of the CPC shape near the coupling of the LED.

In one particular embodiment shown in FIG. 6C, the second mold material 665′ has been removed from the LED projector array 600, exposing a hollow first cavity 655a, a hollow second cavity 655b, and a filled third cavity 655c. In another embodiment, the first and second cavities (655a, 655b) can also be filled cavities.

In one particular embodiment, the second mold material 665′ can be physically removed from the LED projector array 600. In another embodiment, the resin may be cured at a temperature that exceeds the normal operating temperature so that the resin shrinks when cooled. A suitable release coating applied to the second mold material allows the resin to separate from the second mold material and leave an exposed surface to enable TIR. Alternatively, a second mold material 665′ can be used that is elastic, for example, made from silicone, rubber, or polyurethane. In this case, the second mold should be coated with a material that can experience repeated expansion and contraction within the application without effectively losing reflectivity.

The open top face of the CPC allows the cavity material having a high CTE to expand and contract without substantially distorting the CPC. Low distortion can be particularly important near the LED 670, where small changes in surface profiles can result in significant changes in the distribution of light at the output aperture of the CPC. A freely suspended CPC attached to the LED and the optional color combiner elements 690 at the output aperture of the CPC can create optically undesirable strain in the CPC. For example, expansion of the CPC relative to the first mold material 665 holding a silicone CPC will cause the narrow portion of the CPC to distort due to the relatively small cross section near the LED 670. Since the direction of much of the light emitted from the CPC is affected by this distortion, means of control are necessary.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A light emitting diode (LED) projector, comprising:
a heat extraction substrate;
a molded optical element, comprising:
an input aperture, an output aperture, and an inner surface defining a cavity;
an outer surface at least partially surrounding the inner surface, a portion of the outer surface in thermal contact with the heat extraction substrate;
a mold material filling a space between the inner surface and the outer surface; and
an LED disposed to inject a light beam into the input aperture, wherein the injected light beam travels through the cavity and exits the output aperture as a partially collimated light beam.

2. (canceled)

3. (canceled)

4. (canceled)

5. The LED projector of claim 1, wherein the cavity comprises a first polymeric material that is transparent to the light beam.

6. The LED projector of claim 5, wherein the mold material has a first coefficient of thermal expansion (CTE) that is smaller than a second CTE of the first polymeric material.

7. The LED projector of claim 5, wherein the first polymeric material comprises a silicone, an epoxy, an acrylate, or a cyclo-olefin copolymer.

8. The LED projector of claim 1, wherein the mold material comprises a second polymer, a metal, or a ceramic.

9. (canceled)

10. (canceled)

11. (canceled)

12. (canceled)

13. (canceled)

14. (canceled)

15. (canceled)

16. The LED projector of claim 1, wherein the cavity has a square compound parabolic concentrator (CPC) shape.

17. An LED projection array, comprising:
a heat extraction substrate;
a first molded optical element, a second molded optical element, and a third molded optical element, each comprising:
an input aperture, an output aperture, and an inner surface defining a cavity;
an outer surface at least partially surrounding the inner surface, a first portion of the outer surface in thermal contact with the heat extraction substrate;
a mold material filling a space between the inner surface and the outer surface;
a first LED disposed to inject a first light beam into the input aperture of the first molded optical element;
a second LED disposed to inject a second light beam into the input aperture of the second molded optical element; and
a third LED disposed to inject a third light beam into the input aperture of the third molded optical element,
wherein each of the first, second, and third injected light beam exits the respective output aperture as a first, a second, and a third partially collimated light beam, respectively, and wherein at least a second portion of the mold material is continuous across at least two of the first molded optical element, the second molded optical element and the third molded optical element.

18. (canceled)

19. (canceled)

20. (canceled)

21. The LED projection array of claim 17, wherein the cavity comprises a first polymeric material that is transparent to the light beam.

22. The LED projection array of claim 21, wherein the mold material has a first coefficient of thermal expansion (CTE) that is smaller than a second CTE of the first polymeric material.

23. The LED projection array of claim 21, wherein the first polymeric material comprises a silicone, an epoxy, an acrylate, or a cyclo-olefin copolymer.

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. An LED projection array, comprising:
a heat extraction substrate;
a first molded optical element and a second molded optical element, each comprising:
an input aperture, an output aperture, and an inner surface defining a cavity;
an outer surface at least partially surrounding the inner surface, a first portion of the outer surface in thermal contact with the heat extraction substrate;
a mold material filling a space between the inner surface and the outer surface;
a first LED disposed to inject a first light beam into the input aperture of the first molded optical element; and
a second LED disposed to inject a second light beam into the input aperture of the second molded optical element,
wherein each of the first and second injected light beam exits the respective output aperture as a first and a second partially collimated light beam, respectively, and wherein at least a second portion of the mold material is continuous across the first molded optical element and the second molded optical element.

37. (canceled)

38. (canceled)

39. (canceled)

40. (canceled)

41. The LED projection array of claim 36, wherein the cavity comprises a first polymeric material that is transparent to the light beam.

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. A method for producing an LED projector, comprising:
coating an inner surface of a mold with a reflective material, the mold comprising:
an outer surface surrounding the inner surface;
a cavity defined by the inner surface, an input aperture, and an output aperture;
a mold material filling a space between the inner surface and the outer surface;
disposing a portion of the outer surface in thermal contact with a heat extraction substrate; and
positioning an LED to inject a light beam into the input aperture, wherein the injected light beam travels through the cavity and exits the output aperture as a partially collimated light beam.

57. A method for producing an LED projector, comprising:
coating an inner surface of a mold with a reflective material, the mold comprising:
an outer surface surrounding the inner surface;
a cavity defined by the inner surface, an input aperture, and an output aperture;
a mold material filling a space between the inner surface and the outer surface;
disposing a first portion of the outer surface in thermal contact with a heat extraction substrate;
positioning an LED to inject a light beam into the input aperture, wherein the injected light beam travels through the cavity and exits the output aperture as a partially collimated light beam;
filling the cavity with a curable resin;
curing the curable resin; and
removing a second portion of the mold from the cured resin.

58. A method for producing an LED projector, comprising:
coating an inner surface of a mold with a reflective material, the mold comprising:
an outer surface surrounding the inner surface;
a cavity defined by the inner surface, an input aperture, and an output aperture;
a mold material filling a space between the inner surface and the outer surface, wherein a portion of the mold material comprises an elastic material;
disposing a first portion of the outer surface in thermal contact with a heat extraction substrate;
positioning an LED to inject a light beam into the input aperture, wherein the injected light beam travels through the cavity and exits the output aperture as a partially collimated light beam;
filling the cavity with a curable resin; and
curing the curable resin.
